(19) United States
(12) Patent Application Publication
(10) Pub. No.: US 2026/0241342 A1
(43) Pub. Date: Aug. 20, 2026

(54) CONTAINER AND WATER TREATMENT SYSTEM

(71) Applicant: Yokogawa Electric Corporation, Tokyo (JP)

(72) Inventors: Yasuhiro MATSUI, Tokyo (JP); Junji KAMIGUCHI, Tokyo (JP)

(21) Appl. No.: 19/159,441

(22) PCT Filed: Mar. 1, 2024
(86) PCT No.: PCT/JP2024/007893

§ 371 Date: Aug. 25, 2025

(30) Foreign Application Priority Data
Mar. 3, 2023 (JP) 2023-033035

(51) Int. Cl. B01D 61/58; B01D 61/02; B01D 61/12; B01D 61/14; B01D 65/02; C02F 1/00; C02F 1/44; C02F 103/00

(52) U.S. Cl. CPC B01D 61/58; B01D 61/12; B01D 65/02; C02F 1/008; C02F 1/441; C02F 1/444; B01D 61/026; B01D 61/146; B01D 2313/243; B01D 2313/60; B01D 2321/04; B01D 2321/162; B01D 2321/164; B01D 2321/185; C02F 2103/001; C02F 2209/03; C02F 2301/08; C02F 2303/16

(57) ABSTRACT

A container includes a module (element group) that includes multiple UF membranes, a pipe to flow water to the module (inlet pipe), a pipe to collect water from the module (permeate pipe), and a pipe to connect with a device included in a system for treating sewage water (connecting pipe).

### TECHNICAL FIELD

The present invention relates to a container and a water treatment system.

### BACKGROUND ART

Conventionally, water treatment systems that purify treated water using multiple modules, such as ultrafiltration (UF) membrane modules and reverse osmosis (RO) membrane modules, have been known (for example, refer to Patent literature 1).

### CITATION LIST

### Patent Literature

PTL 1: Japanese Laid-open Patent Publication No. 2013-94762

### SUMMARY OF INVENTION

### Technical Problem

The conventional water treatment systems that include membrane modules have a problem in which operational efficiency decreases at times.

For example, in a conventional water treatment plant (one example of the water treatment systems), membrane modules are installed within a concrete structure or building during the construction phase. Therefore, it is not easy to move the membrane modules once installed.

Therefore, for example, to replace membrane elements included in a membrane module, it is necessary to perform attachment and detachment for each of the membrane elements. As a result, the replacement work of membrane elements requires significant man-hours.

Furthermore, during the replacement work of membrane elements, the operation of the water treatment system is suspended. Therefore, the operational efficiency of the water treatment system decreases, as the replacement work takes longer.

The present invention is achieved in view of the above problems, and it is an object of the present invention to suppress reduction of the operational efficiency of water treatment systems.

### Solution to Problem

According to one aspect of embodiments, A container comprising: a module that includes a plurality of UF membranes; a pipe to flow water to the module; a pipe to collect water from the module; and a pipe that connects with a device included in a system such that sewage-treated water can pass through.

### Advantageous Effects of Invention

According to one embodiment, it is possible to suppress reduction of the operational efficiency of water treatment systems.

### BRIEF DESCRIPTION OF DRAWINGS

FIG. 1 is a diagram illustrating a configuration example of a water treatment system according to an embodiment.

FIG. 2 is a diagram illustrating a configuration example of a UF membrane device.

FIG. 3 is a diagram illustrating a configuration example of the UF membrane device and peripheral devices.

FIG. 4 is a diagram illustrating a configuration example of analysis device.

FIG. 5 is a flowchart illustrating a flow of processing of the analysis device.

FIG. 6 is a flowchart illustrating a flow of processing of the analysis device.

FIG. 7 is a diagram explaining about a combination of containers.

FIG. 8 is a diagram illustrating a configuration example of an RO membrane device.

FIG. 9 is a diagram explaining a hardware configuration example.

### DESCRIPTION OF EMBODIMENTS

Hereinafter, embodiments of a container and a water treatment system disclosed in the present application will be explained in detail with reference to the drawings. The embodiments explained herein are not intended to limit the present invention. Moreover, identical reference symbols are assigned to identical components, and duplicated explanation will be omitted as appropriate. Furthermore, the respective embodiments can be combined within a range not causing a contradiction.

Water treatment of sewage, and drainage of rainwater and the like is generally categorized into three main processes including primary treatment, secondary treatment, and tertiary treatment.

In the primary treatment, removal of large solid materials such as foreign objects included in wastewater is performed. In the secondary treatment, organic matter that could not be eliminated in the primary treatment is removed by using microorganisms (bacteria). In the secondary treatment, for example, activated sludge treatment, nitrification-denitrification treatment, and the like are performed. In the tertiary treatment, removal of suspended solids that could not be eliminated in the secondary treatment by sediment removal is performed. In the tertiary treatment, removal of suspended solids by sand filtration or membrane filtration is performed.

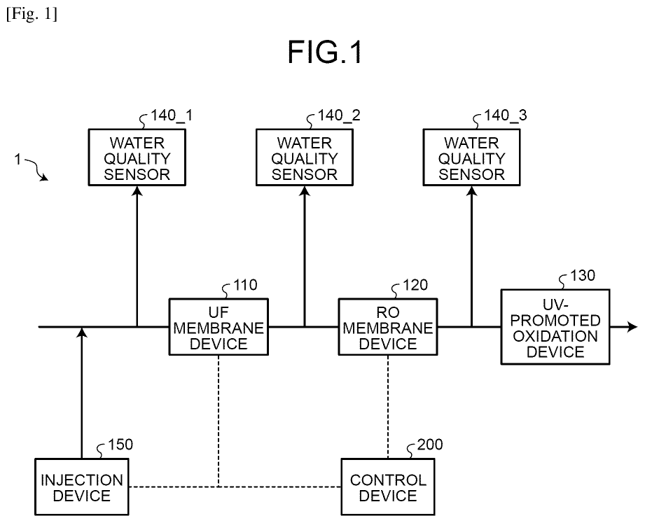

FIG. 1 is a diagram illustrating a configuration example of a water treatment system according to an embodiment for the purpose of reusing sewage-treated water. A water treatment system 1 illustrated in FIG. 1 includes a UF membrane device 110, an RO membrane device 120, a UV-promoted oxidation device 130, a water quality sensor 140_1, a water quality sensor 140_2, a water quality sensor 140_3, an injection device 150, and a control device 200. Note that the water treatment system illustrated in FIG. 1 is one example, and the water treatment system according to the present embodiment may have components other than the components illustrated in FIG. 1.

The water treatment system 1 recycles sewage-treated water into domestic water and drinking water. To the water treatment system 1, for example, treated water obtained by subjecting wastewater to activated sludge treatment, nitrification-denitrification treatment, and the like (that is, treated water that has undergone the primary treatment and the secondary treatment) is supplied. The water treatment system 1 subjects the supplied treated water to membrane treatment and the like. Moreover, to the water treatment system 1, the tertiary treatment may be supplied in some cases.

The treated water treated by the water treatment system 1 is disinfected with, for example, chlorine or the like, and is used as domestic water and drinking water.

The activated sludge treatment, the nitrification-denitrification treatment, and the like are performed, for example, in sewage treatment facility. The water treatment system 1 subjects, for example, wastewater treated at sewage treatment facility to membrane treatment and the like.

Supply water that is supplied to the UF membrane device 110 is also denoted as membrane-filtered supply water. Supply water that is supplied to the RO membrane device 120 is denoted as reverse-osmosis-membrane supply water. Supply water that is supplied to the UV-promoted oxidation device 130 is also denoted as UV supply water.

### UF Membrane Device 110

The UF membrane device 110 removes microorganisms and particulate matter from the supply water with a filtration membrane. The UF membrane device 110 includes multiple UF membranes. The UF membrane device 110 subjects the UF supply water to membrane filtration using the UF membranes, to remove microorganisms and particulate matter. The UF membrane device 110 supplies membrane-filtered permeate water (UF permeate water) after membrane filtration to the RO membrane device 120.

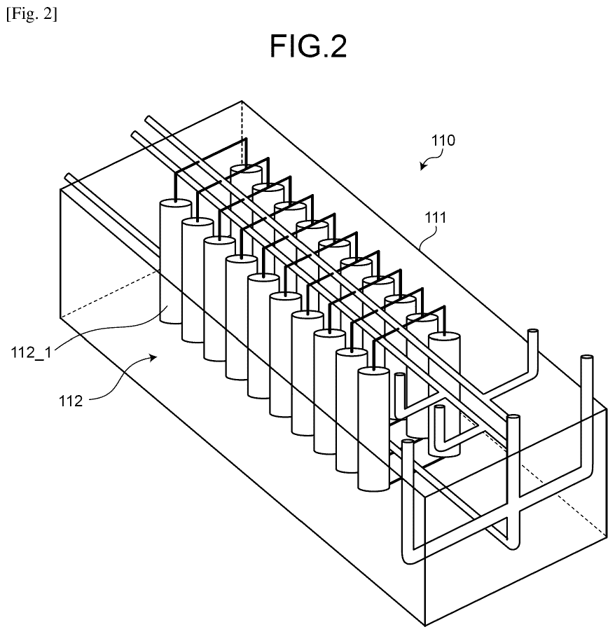

A configuration of the UF membrane device 110 will be explained by using FIG. 2. FIG. 2 is a diagram illustrating a configuration example of the UF-membrane device.

As illustrated in FIG. 2, the UF membrane device 110 includes a container 111 that houses a UF membrane module (UF membrane element group) 112 thereinside. The UF membrane module 112 includes multiple UF membranes (UF membrane elements).

In FIG. 2, reference symbols are omitted except for one UF membrane 112_1. Shapes congruent to a shape (cylinder) indicating the UF membrane 112_1 in FIG. 2 all express UF membranes.

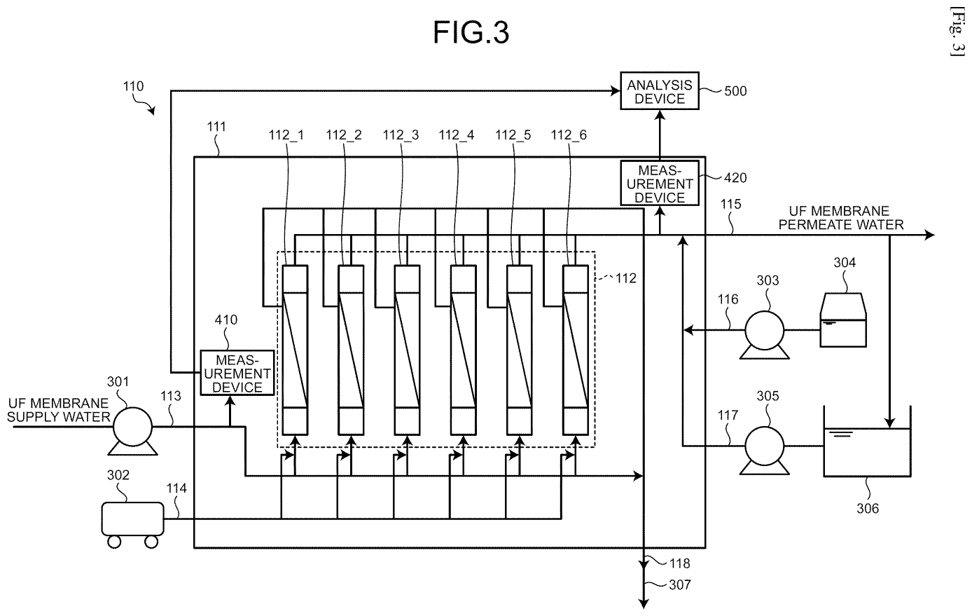

The configuration of the UF membrane device 110 will be explained in more detail by using FIG. 3. FIG. 3 is a diagram illustrating a configuration example of the UF membrane device and peripheral devices.

As illustrated in FIG. 3, the UF membrane module 112 housed in the container 111 includes the UF membrane 112_1, a UF membrane 112_2, a UF membrane 112_3, and a UF membrane 112_4. The number of UF membranes included in the container 111 is not limited to the one illustrated.

The container 111 includes an inlet pipe 113 to supply the UF supply water to the UF membrane module 112. The inlet pipe 113 is connected to a pump 301. The pump in the present embodiment is a feeder pump to supply the supply water to the UF membranes and the like.

The container 111 includes an inlet pipe 114 to supply compressed air for air cleaning to the UF membrane module 112. The inlet pipe 114 is connected to an air compressor 302 that supplies compressed air.

The container 111 includes a permeate pipe 115 for collecting water subjected to membrane filtration from the UF membrane module 112. The permeate pipe 115 supplies water after membrane filtration to a subsequent treatment device (for example, the RO membrane device 120).

Filtration membranes including the UF membranes are periodically cleaned to remove blockage. For example, as cleaning of UF membranes, there are backwashing (cleaning using filtered water), cleaning using chemicals (for example, sulfuric acid, citric acid, and sodium hypochlorite) (maintenance cleaning (MC)), chemical cleaning in which high-concentration chemicals are used and prolonged immersion is performed (recovery cleaning (RC), and the like.

The container 111 includes an inlet pipe 116 to supply chemicals for chemical cleaning to the UF membrane module 112. The inlet pipe 116 is connected to a chemical tank 304 in which the chemical for chemical cleaning is stored through a pump 303.

The container 111 includes an inlet pipe 117 to supply water for backwashing to the UF membrane module 112. the inlet pipe 117 is connected to a backwashing tank 306 that stores water for backwashing through a pump 305.

The container 111 includes a drainpipe 118 to convey wastewater from the UF membrane module 112. The drainpipe 118 is connected to a drainpipe 307 outside the container 111.

Moreover, the container 11 has a connecting pipe to connect the container 11 with other devices. The connecting pipe connects a device that performs the secondary treatment or the RO membrane device 120 with the container 11. Moreover, the pipes including the inlet pipe 113 and the permeate pipe 115 explained so far may serve as the connecting pipe.

The connecting pipe is a mechanism to make the container 11 detachable with respect to the water treatment system 1. The connecting pipe has a fitting for low pressure. The fitting is, for example, a screw-in fitting, a flange, or the like made of stainless steel or polyvinyl chloride material. The connecting pipe is only required to be able to withstand pressure of, for example, approximately 0.49 MPa or lower.

The container 111 includes a measurement device 410 and a measurement device 420 for measuring an amount, pressure, or water quality of water passing through the UF membrane module 112. The measurement device 410 performs measurement of water supplied to the UF membrane module 112. The measurement device 420 performs measurement of water passing through the UF membrane module 112.

The measurement device 410 and the measurement device 420 have at least one of functions of a pressure gauge, a differential pressure gauge, a flow meter, and a water quality meter. The water quality meter measures at least one of pH, oxidation-reduction potential (ORP), ultraviolet transmittance, turbidity, electrical conductivity, total organic carbon (TOC), microbiological data, and residual chlorine.

Moreover, the measurement device 410 and the measurement device 420 communicates a signal with an analysis device 500 by an analog (0 mA to 20 mA, 1 V to 5 V) output, digital (RS232, RS485) output, and a communication protocol such as Modbus.

The analysis device 500 performs analysis for optimizing load imbalance of respective UF membranes of the UF membrane module 112 based on measurement result obtained by the measurement device 410 and the measurement device 420.

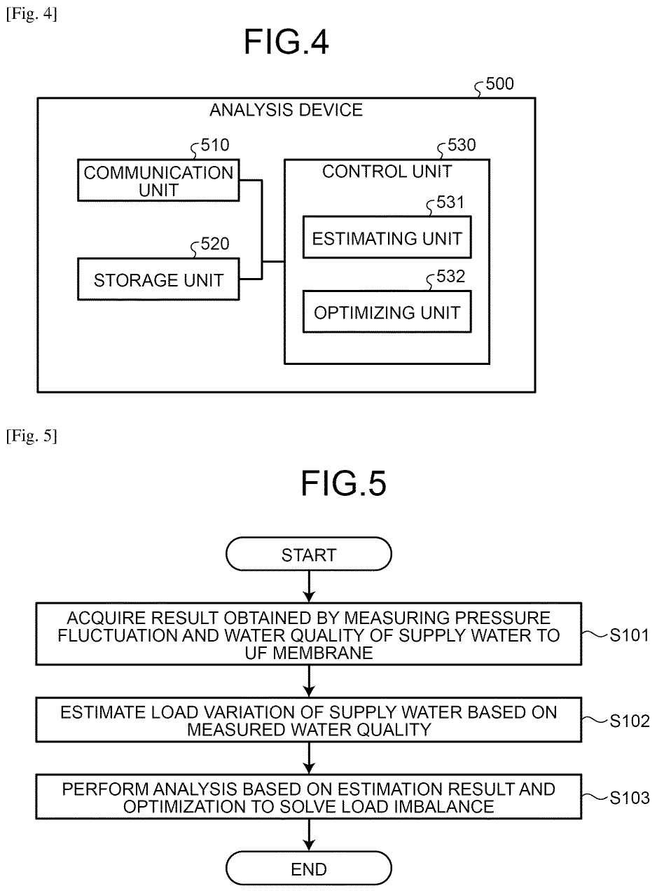

A configuration of the analysis device 500 will be explained by using FIG. 4. FIG. 4 is a diagram illustrating a configuration example of the analysis device. As illustrated in FIG. 4, the analysis device 500 includes a communication unit 510, a storage unit 520, and a control unit 530. Functional units included in the analysis device 500 are not limited to the ones illustrated, and for example, a functional unit such as an interface that transmits and receives data between itself and an output device, such as a display and a speaker, may be included.

The communication unit 510 is a processing unit that controls communication with other devices, and is implemented by, for example, a communication interface. For example, the communication unit 510 controls communication with the measurement device 410 and the measurement device 420.

The storage unit 520 is a processing unit that stores various kinds of data, various kinds of programs executed by the control unit 530, and the like. The storage unit 520 is implemented by, for example, a memory, a hard disk, or the like. This storage unit 520 stores various kinds of data that is generated by processing performed by the analysis device 500, such as data acquired during various kinds of processing performed by the control unit 530 and processing results acquired as a result of performing various kinds of processing.

The control unit 530 is a processing unit that controls the entire analysis device 500. The control unit 530 is implemented by, for example, a processor or the like. The control unit 530 includes an estimating unit 531 and an optimizing unit 532.

The estimating unit 531 estimates the load variation of the UF membrane over time based on measurement results. The optimizing unit 532 performs processing to optimize loads on the UF membrane based on the estimated load variation. The load variation is a predicted value of an amount of various kinds of loads on the UF membrane at a certain time later. The target load may be a physical load such as pressure, or a water quality load, such as water temperature, turbidity, and residual chlorine concentration.

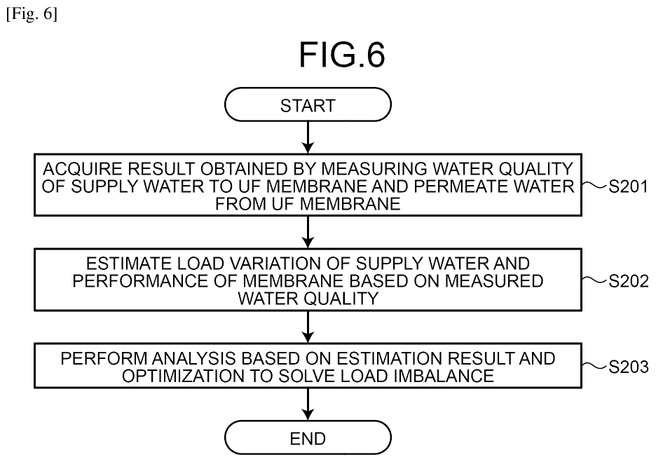

An example of processing of the estimating unit 531 and the optimizing unit 532 will be explained using FIG. 5 and FIG. 6. FIG. 5 and FIG. 6 are flowcharts illustrating a flow of processing of the analysis device. The estimating unit 531 and the optimizing unit 532 perform at least either one of the processing illustrated in FIG. 5 and the processing illustrated in FIG. 6.

The processing of FIG. 5 will be explained. As illustrated in FIG. 5, first, the estimating unit 531 acquires results of measuring pressure fluctuations and the water quality of the supply water to the UF membrane from the measurement device 410 (step S101). The estimating unit 531 acquires at least one of water temperature, turbidity, ultraviolet absorbance, electrical conductivity, and TOC as water quality.

Next, the estimating unit 531 estimates a load variation of the supply water based on the measured water quality (step S102). The optimizing unit 532 performs analysis based on the estimation result and optimization to solve the load imbalance (step S103).

The processing of FIG. 6 will be explained. As illustrated in FIG. 6, first, the estimating unit 531 acquires a result of measurement of a water quality of supply water to the UF membrane and permeate water from the UF membrane (step S201). The estimating unit 531 acquires a result of measurement of the water quality from both the measurement device 410 and the measurement device 420. The estimating unit 531 acquires at least either one of water temperature, pH, ORP, residual chlorine concentration, and microbiological data as the water quality. The microbiological data includes types and quantities of viruses, bacteria, adenosine triphosphate (ATP), and the like.

Next, the estimating unit 531 estimates the load variation of the supply water and a membrane performance based on the measured water quality (step S202). The optimizing unit 532 performs analysis based on the estimation result and optimization to solve the load imbalance (step S203).

The optimizing unit 532 may achieve the optimization by requesting the control device 200 for a control of the water treatment system 1. For example, the optimizing unit 532 requests the control device 200 for such a control of reducing an amount of supply water to the UF membrane that is predicted to have an increased load from the estimation result.

The UF membrane device 110 may include one or more containers for respective purposes. The UF membrane module housed in the container includes a UF membrane used for either one of backwashing, product cleaning, air cleaning, and drainage.

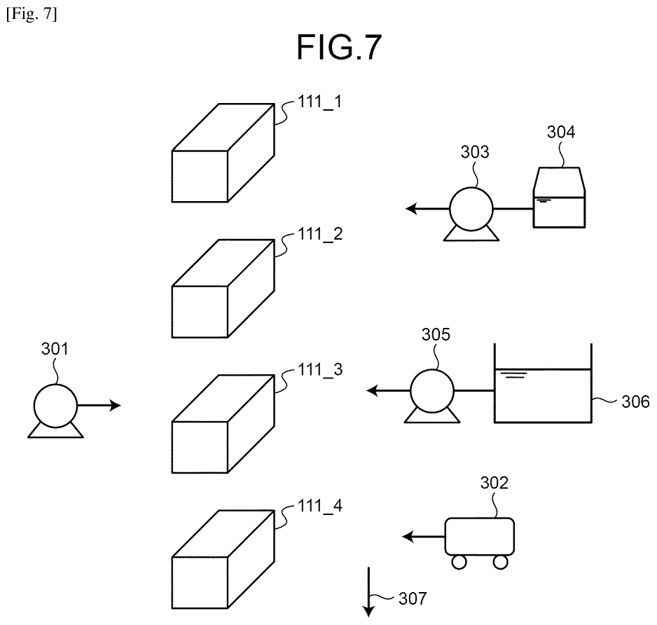

FIG. 7 is a diagram explaining about a combination of the containers. A container 111_1 in FIG. 7 has a UF membrane module including a UF membrane used for backwashing. Moreover, a container 111_2 has a UF membrane module including a UF membraned used for chemical cleaning. Furthermore, a container 111_3 has a UF membrane module including a UF membrane used for air cleaning. Moreover, a container 111_4 has a UF membrane module including a UF membrane used for drainage.

The UF membrane device 110 may be a combination of at least one of the container 111_1, the container 111_2, the container 111_3, and the container 111_4 and at least one of the peripheral devices according to a purpose.

The peripheral device includes the pump 301, the air compressor 302, the pump 303, the chemical tank 304, the pump 305, and the backwashing tank 306.

### RO Membrane Device 120

Returning back to FIG. 1, to the RO membrane device 120, treated water by the UF membrane device 110 is supplied. The RO membrane device 120 removes impurities, such as ions and salts from the supply water. The RO membrane device 120 includes an RO membrane.

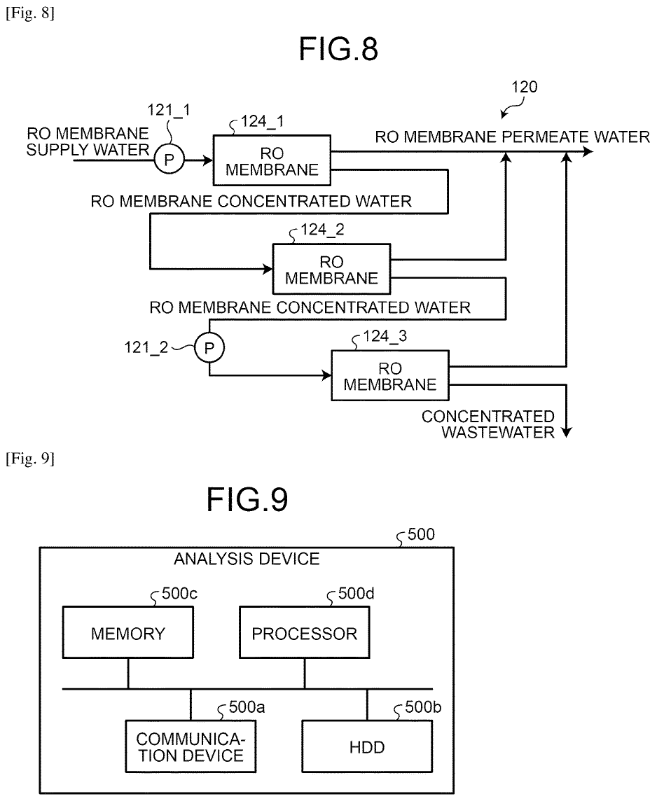

FIG. 8 is a diagram illustrating a configuration example of the RO membrane device. The RO membrane device 120 illustrated in FIG. 8 includes a pump 121_1 and a pump 121_2. Moreover, the UF membrane device 110 includes an RO membrane 124_1, an RO membrane 124_2, and an RO membrane 124_3.

To the RO membrane 124_1, the RO supply water is supplied by using the pump

121_1. The RO membrane 124_1 separates the RO supply water into RO permeate water (RO filtered water) and RO concentrated water. The RO membrane 124_1 supplies the RO concentrated water to the RO membrane 124_2.

The RO membrane 124_2 separates the RO concentrated water into RO permeate water and RO concentrated water. The RO membrane 124_2 supplies the RO concentrated water to the RO membrane 124_3.

To the RO membrane 124_3, the RO concentrated water is supplied from the RO membrane 124_2 by using the pump 121_2. The RO membrane 124_3 separates the RO concentrated water into RO permeate water and concentrated wastewater by using the RO membrane. The RO membrane 124_3 drains the concentrated wastewater to the outside of the RO membrane device 120.

Returning back to FIG. 1, the RO membrane device 120 supplies RO permeate water to the UV-promoted oxidation device 130.

### UV-Promoted Oxidation Device 130

The UV-promoted oxidation device 130 performs UV advanced oxidation process (AOP) (promoted oxidation using ultraviolet rays) with respect to the UV supply water. Thus, the UV-promoted oxidation device 130 oxidizes and decomposes trace chemical substances (for example, NDMA) contained in the UV supply water.

### Water Quality Sensor 140

The water quality sensor 140 measures a water quality of supply water, filtered water (permeate water), or the like of respective parts of the water treatment system 1. In the example of FIG. 1, the water treatment system 1 includes a water quality sensor 140_1, a water quality sensor 140_2, and 140_3.

The water quality sensor 140_1 measures a water quality at an inlet portion of the UF membrane device 110. The water quality sensor 140_1 measures a water quality of the UF-membrane supply water.

The water quality sensor 140_1 measures, for example, at least one of water temperature, pH value, ORP, ammonia nitrogen content, nitrogen compound content, turbidity, ultraviolet absorbance, electrical conductivity, and TOC value of filtered supply water.

The water quality sensor 140_2 measures a water quality at an inlet portion of the RO membrane device 120 (or an outlet portion of the UF membrane device 110). The water quality sensor 140_2 measures a water quality of the RO-membrane supply water (or the UF permeate water).

The water quality sensor 140_3 measures a water quality of an inlet portion of the UF-promoted oxidation device 130 (or an outlet portion of the RO membrane device 120). The water quality sensor 140_3 measures a water quality of the RO permeate water.

The water quality sensor 140 included in the water treatment system 1 is not limited to the example in FIG. 1. For example, the water treatment system 1 may include the water quality sensor 140 that is not illustrated in FIG. 1, such as the water quality sensor 140 that measures a water quality of the UV supply water.

The water quality sensor 140_1 outputs a measurement result to the control device 200.

The injection device 150 injects a chemical solution into the inlet portion of the UF membrane device 110 in accordance with an instruction from the control device 200. The injection device 150 injects, for example, sodium hypochlorite to the inlet portion of the UF membrane device 110. Moreover, the injection device 150 injects, for example, chemical solutions, such as ammonium sulfate and ammonium chloride, other than sodium hypochlorite to the inlet portion of the UF membrane device 110.

The control device 200 controls respective components of the water treatment system 1. The control device 200 may perform control in accordance with a request from the analysis device 500.

### Effects of Embodiment

The container 111 includes the UF membrane module 112 including multiple UF membranes, the pipe to flow water to the UF membrane module 112, the pipe to collect water from the UF membrane module 112, and the pipe that connects with the device included in the water treatment system 1 so that sewage-treated water can pass through. Moreover, the container 111 further includes the measurement device to measure an amount, pressure, or water quality of water passing through the UF membrane module 112.

Conventionally, individual UF membranes have been replaced depending on reduced permeability, passage of a predetermined period of use, and a membrane rupture in each of the UF membrane modules. In this process, it is necessary to detach an individual membrane element from the module, resulting in increased costs (including human resource cost and time cost).

On the other hand, in the present embodiment, it is not necessary to replace individual UF membranes, and the replacement can be performed as a container unit. As a result, cost for replacement is reduced, and reduction of the operational efficiency of the water processing system 1 can be suppressed.

Moreover, it is possible to suppress variations in quality (permeability) of UF membranes in the entire system. Furthermore, by applying the measurement device, a rupture of a membrane due to load imbalance can be prevented, and it is possible to support a user for operation with analysis of indicators related to membrane permeability and degradation.

### System

The processing procedure, the control procedure, specific names and information including various kinds of data and parameters described in the above document and the drawings can be changed arbitrarily unless otherwise specified.

Moreover, the respective components of the respective devices illustrated are of functional concept, and it is not necessarily required to be configured physically as illustrated. That is, specific forms of distribution and integration of the respective devices are not limited to the ones illustrated, and all or some thereof can be configured to be distributed or integrated functionally or physically in arbitrary units according to various kinds of loads, usage conditions, and the like.

Furthermore, as for the respective processing functions performed by the respective devices, all or an arbitrary part thereof can be implemented by a CPU and a computer program that is analyzed and executed by the CPU, or can be implemented as hardware by wired logic.

### Hardware

Next, a hardware configuration of the analysis device 500 will be explained. FIG. 9 is a diagram explaining a hardware configuration example. As illustrated in FIG. 9, the analysis device 500 includes a communication device 500a, a hard disk drive (HDD) 500b, a memory 500c, and a processor 500d. Moreover, the respective components illustrated in FIG. 9 are connected to one another through a bus or the like.

The communication device 500a is a network interface card or the like, and performs communication with other servers. The HDD 500b stores a program to operate the functions illustrated in FIG. 4 and a DB.

The processor 500d reads the program that implements processing similar to that of the respective processing units illustrated in FIG. 4 from the HDD 500b or the like and expands it to the memory 500c, to thereby operate processes to implement the respective functions explained in FIG. 4 and the like. For example, this process performs functions similar to those of the respective processing units included in the analysis device 500. Specifically, the processor 500d reads out a program having functions similar to those of the estimating unit 531, the optimizing unit 532, and the like from the HDD 500b or the like. The processor 500d performs the process to perform the processing similar to that of the estimating unit 531 and the optimizing unit 532.

As described, the analysis device 500 operates as a device that performs a analysis method by reading a program. Moreover, the analysis device 500 can implement functions similar to the embodiment described above by reading the program described above from a recording medium by a medium reader device, and by executing the read program described above also. Programs in other embodiments are not limited to be executed by the analysis device 500. For example, the present invention can be applied similarly also to a case in which the program is executed by other computers or servers, or a case in which the program is executed by these in cooperation.

This program can be distributed through a network such as the Internet. Furthermore, this program can be recorded on a computer-readable recording medium, such as a hard disk, a flexible disk (FD), a CD-ROM, a magneto optical disk (MO), and a digital versatile disk (DVD), and can be executed by being read by a computer from the recording medium.

### Others

Some examples of combinations of the disclosed technical features are described in the following.

(1)

A container comprising:
a module that includes a plurality of UF membranes;
a pipe to flow water to the module;
a pipe to collect water from the module; and
a pipe that connects with a device included in a system such that sewage-treated water can pass through.
   (2)

The container according to claim 1), further comprising
a mechanism detachable with respect to the system.
   (3)

The container according to (1) or (2), wherein
the module includes a UF membrane that is used for either one of backwashing, chemical cleaning, air cleaning, and drainage.
   (4)

The container according to any one of (1) to (3), further comprising
a measurement device that measures any one of an amount, pressure, and water quality of water that passes through the UF membrane module.
   (5)

A water treatment system to reuse sewage-treated water, comprising:
at least one of treatment device that treats water;
a pump to feed water; and
the container according to any one of (1) to (4).

Reference Signs List

1 Water treatment system
110 UF membrane device
111, 111_1, 111_2, 111_3, 111_4 Container
112 UF membrane module
112_1, 112_2, 112_3, 112_4 UF membrane
113, 114, 116, 117 Inlet pipe
115 Permeate pipe
118, 307 Drainpipe
120 RO membrane device
121_1, 121_2, 301, 303, 305 Pump
124_1, 124_2, 124_3 RO membrane
130 UV-promoted oxidation device
140_1, 140_2, 140_3 Water quality sensor
150 Injection device
200 Control device
302 Air compressor
304 Chemical tank
306 Backwashing tank
410, 420 Measurement device
500 Analysis device
510 Communication unit
520 Storage unit
530 Control unit
531 Estimating unit
532 Optimizing unit

1. A container comprising:
a module that includes a plurality of UF membranes;
a pipe to flow water to the module;
a pipe to collect water from the module; and
a pipe that connects with a device included in a system such that sewage-treated water can pass through.

2. The container according to claim 1, further comprising
a mechanism detachable with respect to the system.

3. The container according to claim 1, wherein
the module includes a UF membrane that is used for either one of backwashing, chemical cleaning, air cleaning, and drainage.

4. The container according to claim 1, further comprising
a measurement device that measures any one of an amount, pressure, and water quality of water that passes through the UF membrane module.

5. A water treatment system to reuse sewage-treated water, comprising:
at least one of treatment device that treats water;
a pump to feed water; and
a container, wherein
the container includes
a UF membrane module that includes a plurality of UF membranes;
a pipe to flow water to the UF membrane module;
a pipe to collect water from the UF membrane module; and
a pipe that connects with any one of the treatment device and the pump.

6. The water treatment system according to claim 5, wherein
the treatment device includes an RO membrane module including a plurality of RO membranes, and
the connecting pipe connects the pipe to flow water with the RO membrane module.

7. The water treatment system according to claim 5, wherein
the UF membrane module includes a UF membrane used for backwashing.

8. The water treatment system according to claim 5, wherein
the UF membrane module includes a UF membrane used for chemical cleaning.

9. The water treatment system according to claim 5, wherein
the UF membrane module includes a UF membrane used for air cleaning.

10. The water treatment system according to claim 5, wherein
the UF membrane module includes a UF membrane used for drainage.

11. The water treatment system according to claim 5, comprising:
a container that includes a UF membrane module having a UF membrane used for backwashing;
a container that includes a UF membrane module having a UF membrane used for chemical cleaning;
a container that includes a UF membrane module having a UF membrane used for air cleaning; and
a container that includes a UF membrane module having a UF membrane used for drainage.
